(19) United States
(12) Patent Application Publication
(10) Pub. No.: US 2022/0405951 A1
(43) Pub. Date: Dec. 22, 2022

(54) EFFECTIVE FISHING AND MILLING METHOD WITH LASER DISTANT POINTERS, HYDRAULIC ARMS, AND DOWNHOLE CAMERAS

(71) Applicant: SAUDI ARABIAN OIL COMPANY, Dhahran (SA)

(72) Inventor: Ahmad A. AlOmair, Dhahran (SA)

(73) Assignee: SAUDI ARABIAN OIL COMPANY, Dhahran (SA)

(21) Appl. No.: 17/350,392

(22) Filed: Jun. 17, 2021

(51) Int. Cl. G06T 7/62; G06T 7/521; H04N 5/225; G06K 9/62; E21B 47/002; E21B 31/00

(52) U.S. Cl. CPC G06T 7/62; G06T 7/521; H04N 5/225; G06K 9/6202; E21B 47/002; E21B 31/00; G06T 2207/10028; H04N 2005/2255

(57) ABSTRACT

A method to perform a well maintenance operation is disclosed. The method includes obtaining, using a downhole camera, a downhole image comprising a pixel-based dimension of an object inside the wellbore, generating, using a laser distance pointer, a distance measurement of the object with respect to the downhole camera, determining, based on the distance measurement, a physical dimension of the object from the pixel-based dimension of the object, and performing the well maintenance operation based at least on the physical dimension of the object.

### BACKGROUND

In the oilfield industry, the term “fish” refers to unwanted material left in the wellbore, and the term “fishing” refers to the recovery of fish or removal of other obstructions in the wellbore, such as at the bottom of the wellbore. For example, fishing may be performed when items dropped into the borehole from the rig floor. In another example, failure of surface equipment, especially pumps, may cause the borehole to cave in and stick the drill string to create an obstruction. Further, the term “tripping” refers to the process of removing and/or replacing pipes from the wellbore when it is necessary to change the bit or other piece of the drill string, or when preparing to run certain tests or maintenance tasks in the wellbore.

### SUMMARY

In general, in one aspect, the invention relates to a method to perform a well maintenance operation. The method includes obtaining, using a downhole camera, a downhole image comprising a pixel-based dimension of an object inside the wellbore, generating, using a laser distance pointer, a distance measurement of the object with respect to the downhole camera, determining, based on the distance measurement, a physical dimension of the object from the pixel-based dimension of the object, and performing the well maintenance operation based at least on the physical dimension of the object.

In general, in one aspect, the invention relates to a bottom hole assembly (BHA) for a well maintenance operation. The BHA includes a downhole camera that captures a downhole image comprising a pixel-based dimension of an object inside the wellbore, and a laser distance pointer that generates a distance measurement of the object with respect to the downhole camera, wherein the pixel-based dimension of the object and the distance measurement of the object are sent to an analysis engine for determining a physical dimension of the object from, and wherein the maintenance operation is performed based at least on the physical dimension of the object.

In general, in one aspect, the invention relates to a system of a well maintenance operation. The system includes an object inside a wellbore, a downhole camera that captures a downhole image comprising a pixel-based dimension of the object, a laser distance pointer that generates a distance measurement of the object with respect to the downhole camera, an analysis engine that determines, based on the distance measurement, a physical dimension of the object from the pixel-based dimension of the object, and a maintenance operation controller that performs the well maintenance operation based at least one the physical dimension of the object.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A and 1B show systems in accordance with one or more embodiments.

FIG. 2 shows a flowchart in accordance with one or more embodiments.

FIG. 3 shows an example in accordance with one or more embodiments.

FIGS. 4A and 4B show a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide a method of utilizing downhole cameras equipped with a steering mechanism and laser distance pointers to assess downhole situations, e.g., of fish or any obstructions in wellbore. In one or more embodiments, the downhole cameras, which also include hydraulic arms with catching mechanisms, are installed on a bottom-hole-assembly (BHA) to perform fishing and/or milling operations. Based on images from the downhole cameras and distance measurements from the laser distance pointers, appropriate tools are selected to engage the fish/obstruction and to perform pulling or milling tasks. One or more embodiments reduce non-productive time at the wellsite by identifying the appropriate tool to deploy in advance utilizing the downhole cameras, distance measurements and computed physical dimensions of the downhole object.

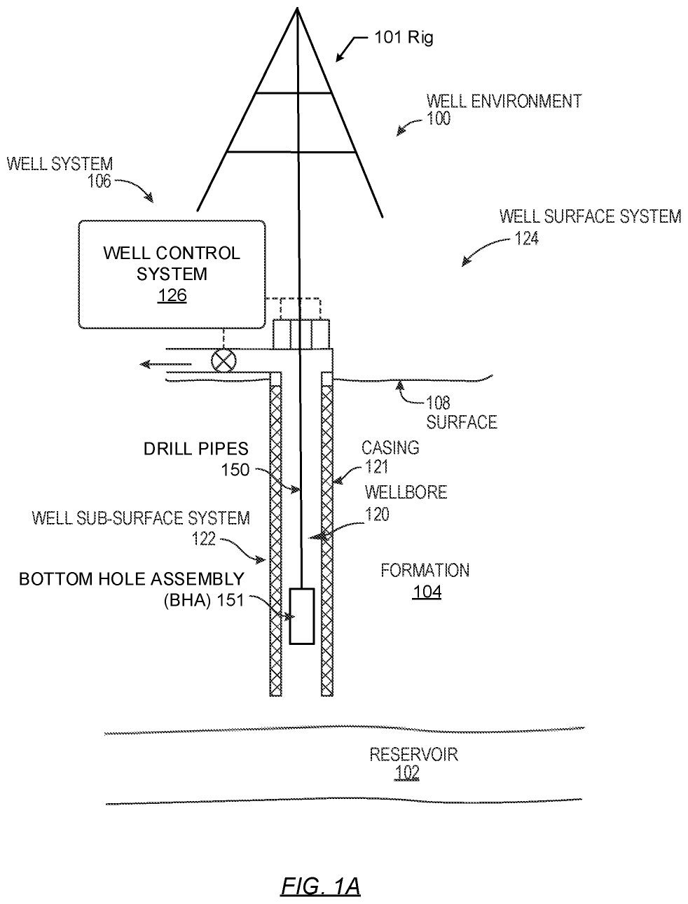

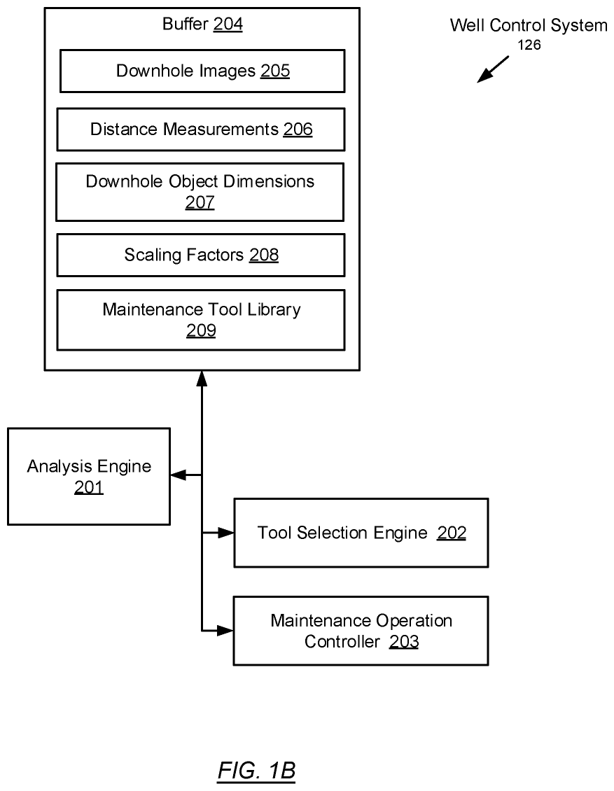

FIG. 1A shows a schematic diagram in accordance with one or more embodiments. As shown in FIG. 1A, a well environment (100) includes a subterranean formation (“formation”) (104) and a well system (106). The formation (104) may include a porous or fractured rock formation that resides underground, beneath the earth's surface (“surface”) (108). The formation (104) may include different layers of rock having varying characteristics, such as varying degrees of permeability, porosity, capillary pressure, and resistivity. In the case of the well system (106) being a hydrocarbon well, the formation (104) may include a hydrocarbon-bearing reservoir (102). In the case of the well system (106) being operated as a production well, the well system (106) may facilitate the extraction of hydrocarbons (or “production”) from the reservoir (102).

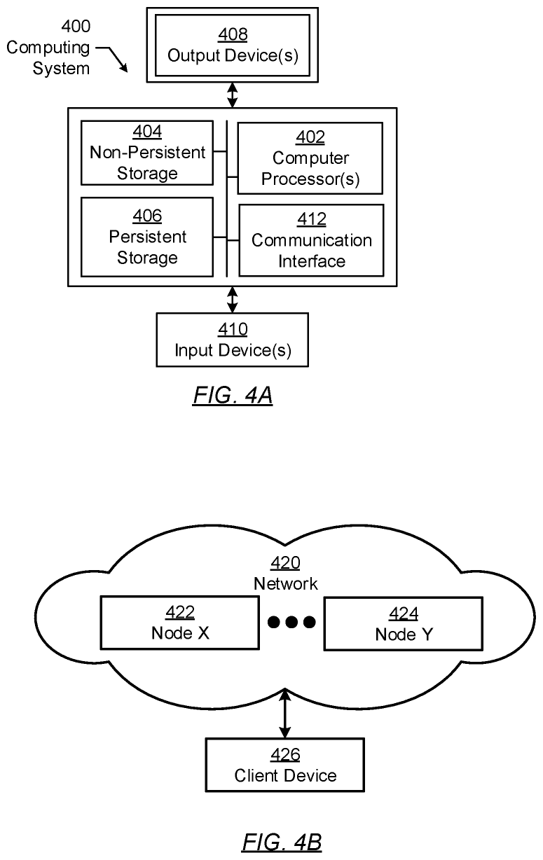

In some embodiments disclosed herein, the well system (106) includes a rig (101), a wellbore (120) with a casing (121), a well sub-surface system (122), a well surface system (124), and a well control system (“control system”) (126). The well control system (126) may control various operations of the well system (106), such as well production operations, well drilling operation, well completion operations, well maintenance operations, and reservoir monitoring, assessment and development operations. For example, the well maintenance operations may include the fishing operation, which recovers a fish or remove an obstruction in the wellbore (120). In another example, the well maintenance operations may include other well maintenance operations, such as to screw in, latch, or mill inside wellbore (120). Example details of a portion of the well control system (126) for performing various well maintenance operations during tripping is described in reference to FIG. 1B below. In some embodiments, the well control system (126) includes a computer system, such as a portion of the computing system described in reference to FIGS. 4A-4B below.

The rig (101) is the machine used to drill a borehole to form the wellbore (120). Major components of the rig (101) include the drilling fluid tanks, the drilling fluid pumps (e.g., rig mixing pumps), the derrick or mast, the draw works, the rotary table or top drive, the drill string, the power generation equipment and auxiliary equipment. Drilling fluid, also referred to as “drilling mud” or simply “mud,” is used to facilitate drilling boreholes into the earth, such as drilling oil and natural gas wells. The main functions of drilling fluids include providing hydrostatic pressure to prevent formation fluids from entering into the borehole, keeping the drill bit cool and clean during drilling, carrying out drill cuttings, and suspending the drill cuttings while drilling is paused and when the drilling assembly is brought in and out of the borehole.

The wellbore (120) includes a bored hole (i.e., borehole) that extends from the surface (108) towards a target zone of the formation (104), such as the reservoir (102). An upper end of the wellbore (120), terminating at or near the surface (108), may be referred to as the “up-hole” end of the wellbore (120), and a lower end of the wellbore, terminating in the formation (104), may be referred to as the “downhole” end of the wellbore (120). The wellbore (120) may facilitate the circulation of drilling fluids during drilling operations for the wellbore (120) to extend towards the target zone of the formation (104) (e.g., the reservoir (102)), facilitate the flow of hydrocarbon production (e.g., oil and gas) from the reservoir (102) to the surface (108) during production operations, facilitate the injection of substances (e.g., water) into the hydrocarbon-bearing formation (104) or the reservoir (102) during injection operations, or facilitate the communication of monitoring devices (e.g., logging tools) lowered into the formation (104) or the reservoir (102) during monitoring operations (e.g., during in situ logging operations).

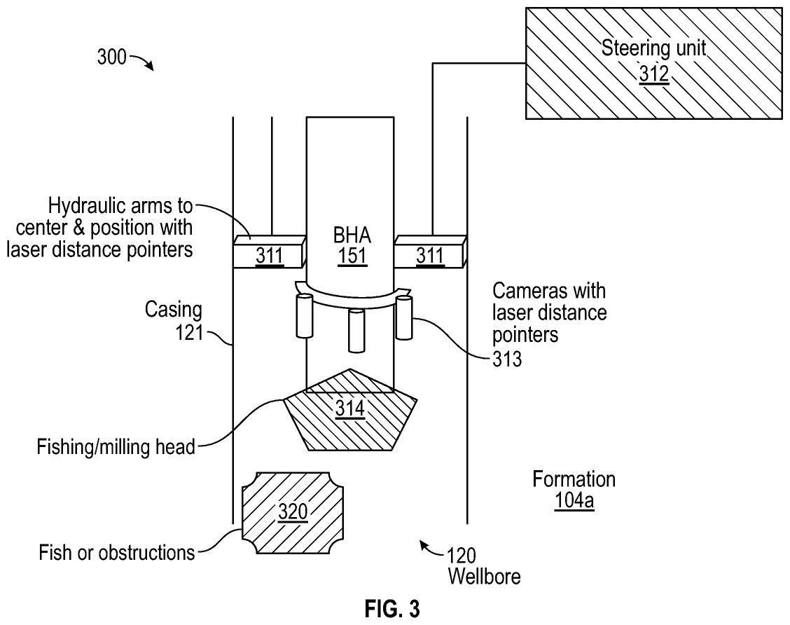

In some embodiments, the well system (106) is provided with a bottom hole assembly (BHA) (151) attached to drill pipes (150) to suspend into the wellbore (120) for performing the well drilling operation. The bottom hole assembly (BHA) is the lowest part of a drill string and includes the drill bit, drill collar, stabilizer, mud motor, etc. Further, in one or more embodiments, the BHA (151) may be installed with one or more downhole cameras, equipped with laser distance pointers and hydraulic arms with catching mechanisms to perform the aforementioned well maintenance operations. The downhole cameras are optical cameras attached to the BHA (151) to capture static and/or video images inside the wellbore. The downhole cameras capture the static/video images using optical sensors that are sensitive to visible light and/or infrared light. The downhole cameras are configured to capture images/video during fishing or milling operations in any suitable format. That is, after well completion, during well operation when well maintenance operations such as fishing operations are required, the BHA (151) may be referred to as a fishing BHA, for example. The fishing BHA is different from the drilling BHA and may include a variety of well maintenance tools as part of the BHA. In such well maintenance scenarios, the BHA (151) may be steered using a steering mechanism through control line unit from surface. More specifically, the BHA (151) may be steered to be in the center of the casing or to one side of the casing, depending on where the physical object that needs to be fished or unstuck is located, and the distance to that physical object. Example details related to the BHA (151) are described in reference to FIG. 3 below.

Turning to FIG. 1B, FIG. 1B illustrates a portion of the well control system (126) depicted in FIG. 1A above. In one or more embodiments, one or more of the modules and/or elements shown in FIG. 1B may be omitted, repeated, combined and/or substituted. Accordingly, embodiments disclosed herein should not be considered limited to the specific arrangements of modules and/or elements shown in FIG. 1B.

As shown in FIG. 1B, FIG. 1B illustrates the well control system (126) that has multiple components, including, for example, a buffer (204), an analysis engine (201), a tool selection engine (202), and a maintenance operation controller (203). Each of these components (201, 202, 203, 204) may be located on the same computing device (e.g., personal computer (PC), laptop, tablet PC, smart phone, multifunction printer, kiosk, server, etc.) or on different computing devices that are connected via a network, such as a wide area network or a portion of Internet of any size having wired and/or wireless segments. Each of these components is discussed below.

In one or more embodiments, the buffer (204) may be implemented in hardware (i.e., circuitry), software, or any combination thereof. The buffer (204) is configured to store data generated and/or used by the well control system (126). The data stored in the buffer (204) includes the downhole images (205), the distance measurements (206), the scaling factors (208), the downhole object dimensions (207), and the maintenance tool library (209).

The downhole images (205) are optical images captured using one or more downhole cameras inside the wellbore. The cameras capture the optical images using optical sensors that are sensitive to visible light and/or infrared light. Each optical image includes a matrix of pixels corresponding to sensing elements of the optical sensor. An object in the optical image is formed by pixels containing pixel values representing shades and/or colors of a physical object inside the wellbore. The size of the object in the optical image may be represented by a number of pixels and is referred to the pixel-based dimension of the corresponding physical object. In one or more embodiments, each downhole camera is attached with, or otherwise mechanically coupled to, a laser distance pointer. In this context, the downhole camera is referred to as a laser distance pointer equipped camera. The laser distance pointer is a distance meter that measures the distance between the laser distance pointer and a point shone on a physical object by a laser beam of the laser distance pointer. In one or more embodiments, the physical object may be a fish, an obstruction, etc.

The distance measurements (206) are measured distances between one or more physical objects inside the wellbore and the laser distance pointer equipped cameras. The distance measurements (206) are generated using laser distance pointers attached to the downhole cameras. The measured distance between the laser distance pointer and the physical object is adjusted based on a known mechanical offset between the laser distance pointer and attached downhole camera to calculate the measured distance between the downhole camera and the physical object.

The downhole object dimensions (207) are physical dimensions of one or more physical objects inside the wellbore. Each of the downhole object dimensions (207) may be measured in feet, inches, meters, centimeters, or any other suitable unit of measurement.

The scaling factors (208) are ratios between physical dimensions (i.e., downhole object dimensions (207)) of physical objects over pixel-based dimensions of corresponding object in the downhole images (205). For an object having a particular size in the downhole images (205), the corresponding physical object may have varying physical sizes depending on how far away the physical object is from the camera. Accordingly, each of the scaling factors (208) for a physical object is proportional to a corresponding measured distance in the distance measurements (206). When the measured distance represents an unit length (e.g., 1 meter, 1 centimeter, 1 foot, 1 inch, etc.), the corresponding scaling factor is referred to as a unit distance scaling factor.

The maintenance tool library (209) is a data library implemented in software for describing physical and functional specifications of a number of well maintenance tools, such as catcher for mechanically catch the physical object, a milling head for milling the physical object, etc. For example, the functional specifications describe each tool found in the library as a catcher, a milling head, or other functional tools. Correspondingly, the physical specifications describe the size, the number of mechanical fingers, etc. of the catcher, the bit type, bit dimension, etc. of the milling head, etc.

In one or more embodiments of the invention, each of the analysis engine (201), tool selection engine (202), and maintenance operation controller (203) may be implemented in hardware (i.e., circuitry), software, or any combination thereof.

In one or more embodiments of the invention, the analysis engine (201) is configured to analyze the downhole images (205) to identify an object in an image and extract a pixel-based dimension for the corresponding physical object in the wellbore. The analysis engine (201) is further configured to compute the physical dimension of the physical object based on the extracted pixel-based dimension and the distance measurement of the physical object.

In one or more embodiments, the tool selection engine (202) is configured to select a well maintenance tool from the maintenance tool library (209) based at least on the computed physical dimension of the physical object in the wellbore. In particular, the selected well maintenance tool is used to engage (e.g., catch, mill, etc.) the physical object to perform the well maintenance operation.

In one or more embodiments of the invention, the maintenance operation controller (203) is configured to steer the selected well maintenance tool to engage the physical object to perform the well maintenance operation. In one or more embodiments, the maintenance operation controller (203) generates control signals to steer and/or activate the selected well maintenance tool to engage the physical object.

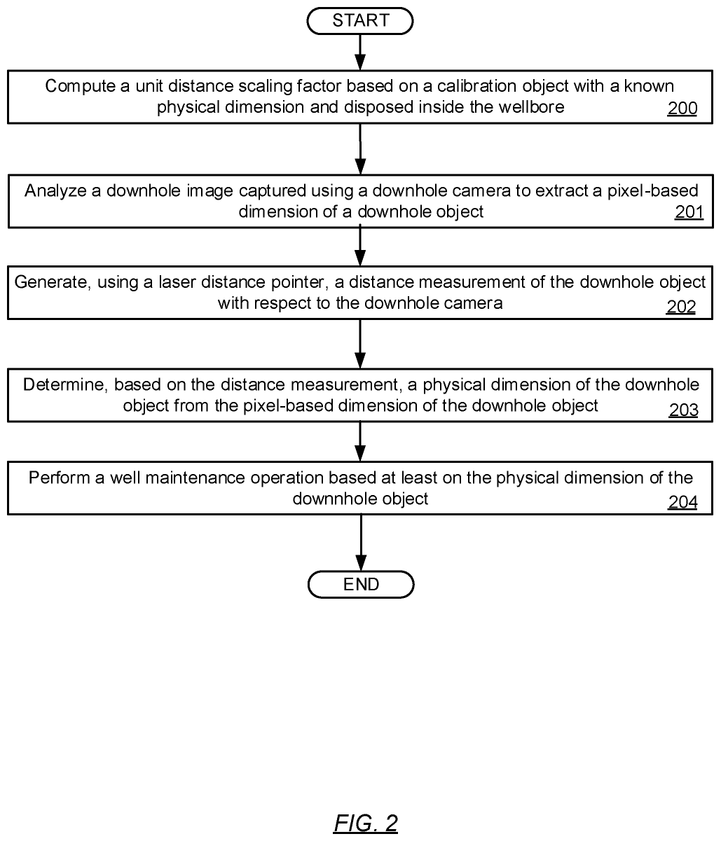

In one or more embodiments, the well control system (126) performs the functionalities described above using the method described in reference to FIG. 2 below. Although the well control system (126) is shown as having three engines (201, 202, 203), in other embodiments of the invention, the well control system (126) may have more or fewer engines and/or more or fewer other components. Further, the functionality of each component described above may be split across components. Further still, each component (201, 202, 203) may be utilized multiple times to carry out an iterative operation.

Turning to FIG. 2, FIG. 2 shows a process flowchart in accordance with one or more embodiments. One or more blocks in FIG. 2 may be performed using one or more components as described in FIGS. 1A and 1B. While the various blocks in FIG. 2 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially in Block 200, during a calibration process, a unit distance scaling factor is computed based on a calibration object with a known physical dimension and disposed inside the wellbore. In the calibration process, a downhole image (referred to as the calibration downhole image) of the calibration object is captured using a downhole camera and analyzed to extract the pixel-based dimension of the calibration object. The distance measurement of the calibration object with respect to the downhole camera is generated using the laser distance pointer. Accordingly, the calibration scaling factor is computed by dividing the known physical dimension of the calibration object over the pixel-based dimension of the calibration object. The unit distance scaling factor is then computed by dividing the calibration scaling factor over the distance measurement of the calibration object. In one or more embodiments, the calibration object is removed from the wellbore subsequent to the calibration process.

In Block 201, during a well maintenance operation, a downhole image is captured using the downhole camera and analyzed to extract the pixel-based dimension of an object in the wellbore (referred to as the downhole object) and detected in the downhole image. The downhole object may be a fish, an obstruction, etc. that need to be engaged during the well maintenance operation. The downhole image may be a static image or an image frame in a video image, such as a real-time video image or a pre-recorded video image.

In Block 202, a distance measurement of the downhole object with respect to the downhole camera is generated using a laser distance pointer. The laser distance pointer measures the distance of the downhole object using a laser beam that shines a point on the downhole object and gets reflected back to compute the distance based on time of flight of the laser beam. The measured distance is adjusted based on a known mechanical offset between the laser distance pointer and the downhole camera.

In Block 203, the physical dimension of the downhole object is determined from the pixel-based dimension of the downhole object based on the distance measurement of the downhole object. Specifically, a scaling factor is first computed by multiplying the distance measurement of the downhole object and the unit distance scaling factor determined in the calibration process. The physical dimension of the downhole object is then computed by multiplying the pixel-based dimension of the downhole object by the computed scaling factor.

In Block 204, the well maintenance operation is performed based at least on the computed physical dimension of the downhole object. In one or more embodiments, a downhole tool to catch or mill the downhole object inside the wellbore is selected from a maintenance tool library based at least on the computed physical dimension of the downhole object. In particular, the selection is based on comparing the computed physical dimension of the downhole object to the physical and functional specifications of the well maintenance tool. The comparison is to ensure that the well maintenance tool is capable of securely engaging the downhole object during the well maintenance operation. In an example scenario, if the comparison indicates that the currently deployed tool is not capable of securely engaging the downhole object, the BHA is tripped to the surface such that the attached well maintenance tool can be replaced. Once the tool replacement is complete, the BHA is tripped into the wellbore to resume the well maintenance operation.

In one or more embodiments, a hydraulic arm for the selected well maintenance tool is steered, based at least on the downhole image and the distance measurement, to position the laser distance pointer equipped downhole camera and/or the well maintenance toll to engage the downhole object inside the wellbore during the well maintenance operation. In particular, control signals are generated based on displacement between the well maintenance tool and the downhole object as detected in the static/video downhole image. Control signals are sent from the surface to maneuver the hydraulic arm to approach the downhole object until the distance measurement reaches zero indicating physical contact between the arm and the object such that the arm may catch the object. The physical contact may be additionally verified in the static and/or video downhole image. The control signal may be sent directly from the well control system at the surface, or via a steering unit attached to the BHA. The physical contact and additional verification may be identified in the downhole image by a human operator or by automatic control algorithms of the well control system. The hydraulic arm may be steered in real-time based on the downhole image from a real-time video image. Alternatively or in combination, the hydraulic arm may be steered based on the downhole image from a pre-recorded video image.

In one or more embodiments, the hydraulic arms and well maintenance tools are made of carbon steel alloy. The hydraulic arms may be bow spring shaped similar to a car lifter for flat tires. The hydraulic arms are controlled by sending pressurized fluid through pistons to activate the arms to be fully opened, half opened, and/or fully closed hydraulically. As an alternative to the hydraulic arm, robotic arms using electrical motors may also be used to position the laser distance pointer equipped camera and/or the selected well maintenance tool to engage the downhole object.

FIG. 3 shows an example in accordance with one or more embodiments. The example shown in FIG. 3 is based on the system and method described in reference to FIGS. 1A-2 above. In particular, FIG. 3 shows an example system (300) for performing well maintenance operations using the well control system (126) depicted in FIGS. 1A-1B above. Well maintenance operations, as depicted in FIG. 3, are performed by installing downhole cameras with hydraulic arms controlled via a steering mechanism and laser distance pointers to assist any tripping to screw in, latch, fish, or mill inside the wellbore.

Specifically, the system (300) includes the BHA (151) suspended inside the wellbore (120) with the casing (121), as depicted in FIG. 1A above, and additionally the system (300) includes a downhole object (320) inside the wellbore (120), one or more hydraulic arms (311) for centering and positioning the BHA (151), a steering unit (312) for steering the hydraulic arms (311), one or more laser distance pointer equipped cameras (313) attached to the BHA (151), and a downhole tool (314) used to screw in, latch, fish, or mill the downhole object (320).

In an example scenario, the downhole object (320) may be a fish or other obstruction at the bottom or otherwise inside the wellbore (120). As depicted in FIG. 3, the system (300) is assembled and calibrated (e.g., according to Block 200 depicted in FIG. 2 above) before any fishing or milling tasks. To meet task-specific requirements of the fishing or milling tasks, the BHA (151) is steered via the steering units (312) to be in the center or on the side of the downhole object (320) based on the downhole images and distance measurements obtained from the laser distance pointer equipped cameras (313). While the BHA (151) is being steered, the downhole images and distance measurements are analyzed to verify whether the downhole tool (314) (e.g., fishing/milling head) is adequately positioned with respect to the downhole object (320). In particular, the hydraulic arms (311) are steered via the steering unit (312) from surface not only for positioning the BHA but also for recording images/video by the camera from all angles downhole to assess the downhole situation. Thus, the hydraulic arms may be steered from the surface in order to move the camera to allow for recording from different points of view/angles. For example, the steering unit (312) may be a downhole unit attached to, or be a part of, the BHA (151) and receives control signals from the well control system (126) depicted in FIGS. 1A-1B above. In another example, the steering unit (312) may itself be a part of the well control system (126) that sends control signals directly to the hydraulic arms (311). The laser distance pointers of the cameras (313) measure the fish dimensions to confirm if the downhole tool (314) (e.g., fishing/milling head) is able to securely catch or otherwise access the downhole object (320). Specifically, the distance measurements are used to compute a ratio between pixel-based dimensions of the fish in the downhole images and physical dimensions of the fish inside the wellbore. Accordingly, the physical dimensions of the fish are computed based on corresponding pixel-based dimensions determined in the downhole images and the distance measurements obtained from the laser distance pointers. If the computed length and/or width of the fish are within the limits for the downhole tool (314) to securely catch the downhole object (320), the fishing operation can proceed. Otherwise, if the computed length and/or width of the fish are too large or too small for the downhole tool (314) to securely catch the downhole object (320), the fishing operation is halted until another suitable tool is deployed to replace the unsuitable tool.

If the fish (i.e., object (320) is cemented or jammed and cannot be moved, the downhole images and distance measurements of the laser distance pointer equipped cameras (313) are used to steer the hydraulics arms (311) to point the milling head (i.e., downhole tool (314)) to the obstruction (i.e., jammed object (320)). If the fish is of a unknown type or lying on one side, the steerable arms with laser pointers will be able to locate, identify, and fish or mill the unknown fish. In addition, the laser distance pointers of the cameras (313) can measure the fish shapes and dimensions from different view angles by guiding the hydraulic arms (311) to rotate or otherwise re-position the fish to present different sides/faces of the fish to the laser distance pointer equipped cameras.

Based on the foregoing, using the system (300) minimizes unsuccessful trips, expenses, and time to recover a fish that cannot readily be seen or engaged due to various drilling challenges. Specifically, the use of the system (300) improves assessment of the downhole situations (obstructions, unstable formations, damaged casing, etc.) such that appropriate downhole tools are selected in real-time in order to successfully perform the well maintenance operations. As a result, non-productive time at the wellsite is reduced by knowing which tool to deploy in advance by using the cameras, distance measurements and computed physical dimensions of the downhole object. Further, embodiments disclosed herein may be used to fish/mill obstructions in deviated and/or horizontal wells, and is not limited to vertical wells.

Embodiments may be implemented on a computing system. Any combination of mobile, desktop, server, router, switch, embedded device, or other types of hardware may be used. For example, as shown in FIG. 4A, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (400) in FIG. 4A may be connected to or be a part of a network. For example, as shown in FIG. 4B, the network (420) may include multiple nodes (e.g., node X (422), node Y (424)). Each node may correspond to a computing system, such as the computing system shown in FIG. 4A, or a group of nodes combined may correspond to the computing system shown in FIG. 4A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (400) may be located at a remote location and connected to the other elements over a network.

Although not shown in FIG. 4B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (for example, node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 4A. Further, the client device (426) may include or perform all or a portion of one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method to perform a well maintenance operation, comprising:
obtaining, using a downhole camera, a downhole image comprising a pixel-based dimension of an object inside the wellbore;
generating, using a laser distance pointer, a distance measurement of the object with respect to the downhole camera;
determining, based on the distance measurement, a physical dimension of the object from the pixel-based dimension of the object; and
performing the well maintenance operation based at least on the physical dimension of the object.

2. The method of claim 1, wherein performing the well maintenance operation comprises:
selecting, based at least on the physical dimension of the object, a downhole tool to catch or mill the object inside the wellbore,
wherein the object is at least one selected from a group consisting of a fish and an obstruction.

3. The method of claim 1, wherein performing the well maintenance operation comprises:
steering, based at least on the downhole image and the distance measurement, a hydraulic arm for a downhole tool to engage the object inside the wellbore.

4. The method of claim 1, wherein performing the well maintenance operation comprises:
verifying, based at least on the downhole image and the distance measurement, a deployed downhole tool as suitable to engage the object inside the wellbore.

5. The method of claim 1, further comprising:
analyzing the downhole image to extract the pixel-based dimension of the object;
determining, based on the distance measurement of the object, a scaling factor from the pixel-based dimension of the object to the physical dimension of the object,
wherein determining the physical dimension of the object comprises multiplying the pixel-based dimension of the object by the scaling factor to compute the physical dimension of the object.

6. The method of claim 5, further comprising:
computing a unit distance scaling factor based on a calibration object with a known physical dimension and disposed inside the wellbore,
wherein determining the scaling factor is by multiplying the distance measurement of the object and the unit distance scaling factor.

7. The method of claim 6, further comprising:
obtaining, using the downhole camera, a calibration downhole image comprising the pixel-based dimension of the calibration object;
analyzing the calibration downhole image to extract the pixel-based dimension of the calibration object;
generating, using the laser distance pointer, the distance measurement of the calibration object with respect to the downhole camera;
computing a calibration scaling factor by dividing the known physical dimension of the calibration object over the pixel-based dimension of the calibration object; and
computing the unit distance scaling factor by dividing the calibration scaling factor over the distance measurement of the calibration object.

8. A bottom hole assembly (BHA) for a well maintenance operation, comprising:
a downhole camera that captures a downhole image comprising a pixel-based dimension of an object inside the wellbore; and
a laser distance pointer that generates a distance measurement of the object with respect to the downhole camera,
wherein the pixel-based dimension of the object and the distance measurement of the object are sent to an analysis engine for determining a physical dimension of the object from, and
wherein the maintenance operation is performed based at least on the physical dimension of the object.

9. The BHA of claim 8, further comprising:
a downhole tool that catches or mills the object inside the wellbore to perform the maintenance operation,
wherein the object is at least one selected from a group consisting of a fish and an obstruction,
wherein the downhole tool is selected from a maintenance tool library based at least on the physical dimension of the object.

10. The BHA of claim 8, further comprising:
a hydraulic arm that positions a downhole tool to engage the object inside the wellbore to perform the maintenance operation,
wherein the hydraulic arm is steered based at least on the downhole image and the distance measurement.

11. The BHA of claim 8, further comprising:
a downhole tool to perform the maintenance operation,
wherein the downhole tool is verified, based at least on the downhole image and the distance measurement, as suitable to engage the object inside the wellbore.

12. The BHA of claim 8, wherein determining the physical dimension of the object comprises:
analyzing the downhole image to extract the pixel-based dimension of the object;
determining, based on the distance measurement of the object, a scaling factor from the pixel-based dimension of the object to the physical dimension of the object; and
multiplying the pixel-based dimension of the object by the scaling factor to compute the physical dimension of the object.

13. The BHA of claim 12, wherein determining the physical dimension of the object further comprises:
computing a unit distance scaling factor based on a calibration object with a known physical dimension and disposed inside the wellbore,
wherein determining the scaling factor is by multiplying the distance measurement of the object and the unit distance scaling factor.

14. The BHA of claim 13, wherein determining the physical dimension of the object further comprises:
obtaining, using the downhole camera, a calibration downhole image comprising the pixel-based dimension of the calibration object;
analyzing the calibration downhole image to extract the pixel-based dimension of the calibration object;
generating, using the laser distance pointer, the distance measurement of the calibration object with respect to the downhole camera;
computing a calibration scaling factor by dividing the known physical dimension of the calibration object over the pixel-based dimension of the calibration object; and
computing the unit distance scaling factor by dividing the calibration scaling factor over the distance measurement of the calibration object.

15. A system of a well maintenance operation, comprising:
an object inside a wellbore;
a downhole camera that captures a downhole image comprising a pixel-based dimension of the object;
a laser distance pointer that generates a distance measurement of the object with respect to the downhole camera;
an analysis engine that determines, based on the distance measurement, a physical dimension of the object from the pixel-based dimension of the object; and
a maintenance operation controller that performs the well maintenance operation based at least one the physical dimension of the object.

16. The system of claim 15, further comprising:
a downhole tool that catches or mills the object; and
a tool selection engine that selects the downhole tool from a maintenance tool library and based at least on the physical dimension of the object,
wherein the object is at least one selected from a group consisting of a fish and an obstruction.

17. The system of claim 15, further comprising:
a hydraulic arm that positions a downhole tool to engage the object inside the wellbore,
wherein the hydraulic arm is steered based at least on the downhole image and the distance measurement.

18. The system of claim 15, further comprising:
a downhole tool that catches or mills the object; and
a tool selection engine that verifies, based at least on the downhole image and the distance measurement, the downhole tool as suitable to engage the object inside the wellbore.

19. The system of claim 15, further comprising an analysis engine that
analyzes the downhole image to extract the pixel-based dimension of the object;
determines, based on the distance measurement of the object, a scaling factor from the pixel-based dimension of the object to the physical dimension of the object,
wherein determining the physical dimension of the object comprises multiplying the pixel-based dimension of the object by the scaling factor to compute the physical dimension of the object.

20. The system of claim 19,
wherein the analysis engine further computes a unit distance scaling factor based on a calibration object with a known physical dimension and disposed inside the wellbore, and
wherein determining the scaling factor is by multiplying the distance measurement of the object and the unit distance scaling factor.
